(19) United States
(12) Patent Application Publication
(10) Pub. No.: US 2006/0224902 A1
(43) Pub. Date: Oct. 5, 2006

(54) Data management system for removable storage media

(76) Inventor: Thomas B. Bolt, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/392,068

(22) Filed: Mar. 29, 2006

Related U.S. Application Data
(60) Provisional application No. 60/666,913, filed on Mar. 30, 2005.

(51) Int. Cl. G06F 12/14

(52) U.S. Cl. 713/193

(57) ABSTRACT

Cryptographic keys or metadata implement timely deletion of data stored on removable storage media that has exceeded its desired lifespan. The data itself is not destroyed, rather metadata is deleted or the data is encrypted at the time it is written, and the encryption key used for the data is deleted. The data is thereby rendered incomprehensible. The encryption/decryption process may be performed in hardware by the device that reads/writes the removable storage media. The encryption/decryption process is transparent to software interfacing with the read/write device and is performed automatically whenever a piece of removable storage media is detected as having an encryption key present. Thus, this encryption does not provide confidentiality, although a separate confidentiality encryption key may be used to encrypt the temporary encryption key. In one embodiment a circuit within each case or carrier for removable storage media is capable of autonomously deleting the temporary encryption key.

### CROSS REFERENCE TO RELATED APPLICATIONS

This application claims priority to U.S. Provisional Application No. 60/666,913 entitled “Encryption and Encryption Key Management System for Removable Storage Media” and filed on Mar. 30, 2005, which is hereby incorporated by reference in its entirety.

### BACKGROUND

Removable storage media is often used for long term archival storage of data. The removable nature of this media lends itself to off-line and/or off-site storage of data. In many situations there are business policies, regulations, or laws that require data to be kept for minimum time, after which the data may represent a liability to the data's owner. It is often the case that this timely destruction of data that has exceeded its minimum lifespan is difficult. It is not uncommon for the physical location of removable storage media to be unknown due to errors in shipment or storage. It is also the case that removable media may be called back from the off-site vaulting location for legitimate access purposes and never returned to the vault. Another potential problem for the timely destruction of expired data is the loss of the catalog or index of the data such that the contents of individual removable storage media is unknown without reading the media, an expensive and time consuming task. Additionally it is often time consuming and labor intensive to destroy the contents of removable media even when the media is readily accessible. Finally, unencrypted data on removable media represents a risk for the loss or theft of confidential information.

Tape drives and some disk drives have had the capability of encrypting data for several years. The management of the keys used for encryption has been the responsibility of the application used to write the data to the device. Since the data contained upon an encrypted device is incomprehensible without the associated encryption keys, the loss of said keys is catastrophic. For this reason the encryption keys are typically protected by means of backup or maintenance of multiple copies. These additional copies of the encryption keys represent a liability since to effectively destroy the data on encrypted devices the device must be erased, overwritten, or all copies of the keys used to encrypt the data must be destroyed. Typically data management applications expire the catalog or index for a piece of removable media making it eligible for reuse, with no guarantees that the data on the removable media will actually be destroyed in a timely manner, if ever.

Another method employed to delete expired data is to keep the data on an on-line storage device and erase or overwrite the data upon expiration. These solutions do not face the same access time requirements and physical location challenges of removable media.

### SUMMARY OF CERTAIN INVENTIVE ASPECTS

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Preferred Embodiments” one will understand how the features of this invention provide advantages over other removable storage media devices.

One embodiment includes a method of data storage management, which comprises: storing data encrypted with a temporary encryption key; storing the temporary encryption key; storing an expiration condition for the temporary encryption key; determining whether the expiration condition has been satisfied; and deleting the temporary encryption key upon the expiration condition being satisfied.

In some embodiments a method may also include encrypting the temporary encryption key with a confidentiality encryption key

Another embodiment includes a method of data storage management, which comprises: storing data encrypted with a temporary encryption key on a removable data storage medium; storing the temporary encryption key on the removable data storage medium; storing an expiration condition for the temporary encryption key on the removable data storage medium; determining whether the expiration condition has been satisfied; and deleting the temporary encryption key upon the expiration condition being satisfied.

In some embodiments a method may also include removing the removable data storage media from a read/write device after storing the expiration condition and prior to determining whether the expiration condition has been satisfied.

One embodiment of a removable data storage medium device comprises: means for storing a temporary encryption key, data encrypted with the temporary encryption key, and an expiration condition; and means for deleting the temporary encryption key upon receiving an indication signal that the expiration condition has been satisfied.

Other embodiments may also include means for receiving a time-varying signal from an external source; and means for determining whether the expiration condition has been satisfied, configured to selectively generate an indication signal based on a comparison of the time-varying signal to the expiration condition.

Another embodiment of a removable data storage media device comprises: means for storing a temporary encryption key, data encrypted with the temporary encryption key, and an expiration condition; means for generating a time-varying signal; means for determining whether the expiration condition has been satisfied, configured to selectively generate an indication signal based on a comparison of the time-varying signal to the expiration condition; and means for deleting the temporary encryption key upon receiving the indication signal that the expiration condition has been satisfied.

Yet another removable data storage device comprises: a persistent data storage, configured to store data encrypted with a temporary encryption key, the temporary encryption key, and an expiration condition for the temporary encryption key; and a control circuit configured to delete the encryption key from the persistent data storage upon receiving an indication signal that the expiration condition has been satisfied.

Other embodiments also include a first circuit configured to receive a time-varying signal from an external source; and a second circuit configured to generate an indication signal based on a comparison of the time-varying signal to the expiration condition.

One embodiment of a removable data storage device comprises: a persistent data storage, configured to store data encrypted with a temporary encryption key, the temporary encryption key, and an expiration condition for the temporary encryption key; a control circuit configured to delete the encryption key from the persistent data storage upon receiving an indication signal that the expiration condition has been satisfied; a first circuit configured to provide a time-varying signal; and a second circuit configured to generate the indication signal based on a comparison of the time-varying signal to the expiration condition.

Some embodiments are configured such that the first circuit comprises a timer circuit; and the second circuit comprises a comparison circuit.

### BRIEF DESCRIPTION OF THE DRAWINGS

FIG. 1 is a flowchart illustrating an embodiment of encryption key data security management.

FIG. 2 illustrates a removable media for use in an embodiment of encryption key data security management.

FIGS. 3A and 3B are flowcharts illustrating an embodiment of encryption key data security management.

FIG. 4 is a flowchart illustrating an embodiment of encryption key data security management.

### DETAILED DESCRIPTION OF CERTAIN INVENTIVE EMBODIMENTS

The following detailed description is directed to certain specific embodiments. However, the invention can be embodied in a multitude of different ways. In this description, reference is made to the drawings wherein like parts are designated with like numerals throughout. As will be apparent from the following description, the invention may be implemented in at least any system that is configured to encrypt data, store data, keep track of time, and delete data, such as, but not limited to removable data storage media, computers, mobile telephones, televisions, wireless devices, personal data assistants (PDAs), hand-held computers, GPS receivers/navigators, cameras, MP3 players, camcorders, game consoles, wrist watches, clocks, calculators, and other electronic devices.

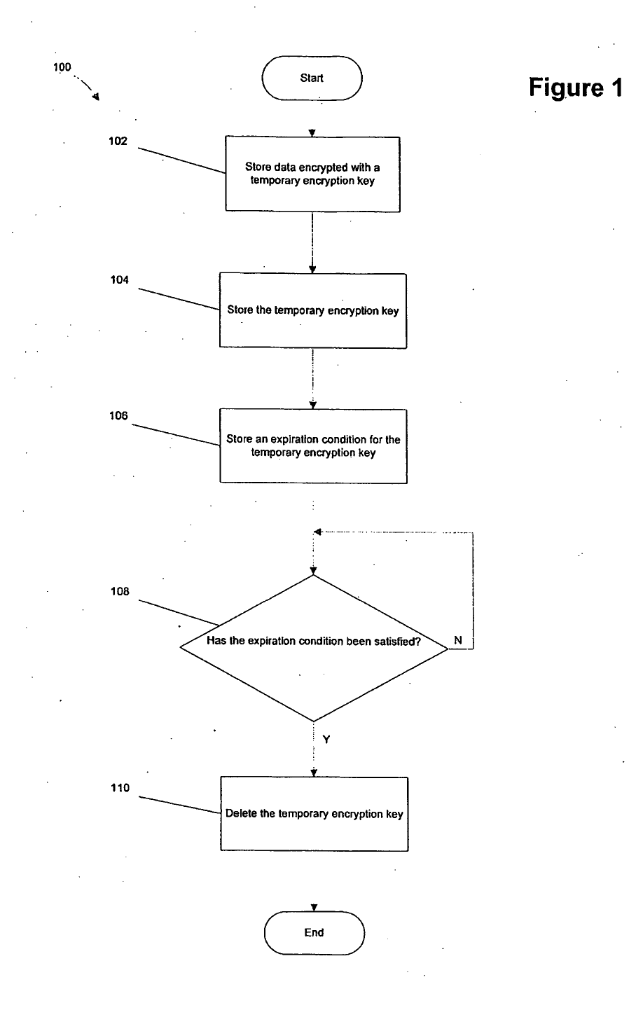

FIG. 1 illustrates an embodiment, process 100. The following discussion will describe process 100 as it is embodied using a removable storage media, however it is understood that this process may be embodied using other types of devices. Depending on the embodiment, certain states of process 100 can be removed, added, or rearranged. Starting at state 102 data is encrypted with a temporary encryption key and stored on a removable storage media. The temporary encryption key is tied to an individual piece of removable storage media, and ideally is both unique and random. In one embodiment an API could be created to allow either a library device or external application to set the temporary encryption key. In another embodiment the read/write device itself generates the temporary encryption key with a random number generation algorithm. In this manner the temporary encryption key would have a high probability of being unique to a individual piece of removable storage media.

Proceeding to state 104, the temporary encryption key is stored. In one embodiment the temporary encryption key is stored with the removable storage media, either on an independent storage device within the case or enclosure for the removable storage media, or on the main storage area of the media itself. In other embodiments the temporary encryption key is stored in other volatile or non-volatile memory. The temporary encryption key is used by the read/write device and may not need to be accessed by anything other than the read/write device.

In one embodiment the temporary encryption key is stored on a non-volatile device such as, but not limited to FLASH memory or EEPROM. This non-volatile memory may be accessible by both an external interface such as, but not limited to, a passive RF read/write interface and an internal circuit responsible for erasing, over-writing, or destroying the temporary encryption key upon expiration. For simplicity the term delete will be used to mean any of these operations or any other operation which renders an encryption key or data as unusable. In another embodiment the temporary encryption key may be stored on a volatile memory device such as, but not limited to SDRAM. This volatile storage may be accessible by both a small internal circuit configured to delete the temporary encryption key, and an external interface such as, but not limited to a passive RF read/write interface.

To ensure data confidentiality, the temporary encryption key itself may be encrypted with a separate encryption key (a confidentiality key). The confidentiality key may be common across all removable media, shared among distinct groups of media, or assigned on an individual basis. Since the temporary encryption key is used when present for all data access it does not provide data confidentiality. By use of a confidentiality key, the data's owner can ensure that if their removable storage media is lost or stolen it can not be read without possession of the confidentiality key. If the confidentiality key is common across all removable media for the data's owner, it may be maintained by the read/write device, by a library device, or by other devices suited for such a purpose. In cases where application software already manages device level encryption, the existing API for setting encryption keys can be used to set the confidentiality key.

Advancing to state 106, an expiration condition for the temporary encryption key is stored. In one embodiment the expiration condition is stored with the removable storage media, either on an independent storage device within the case or enclosure for the removable storage media, or on the main storage area of the media itself. In other embodiments the encryption key is stored in other volatile or non-volatile memory. An expiration date and/or timestamp may be assigned to the individual piece of removable storage media at the time that the time sensitive data is written to the media. This date and or timestamp may be tied to an offset from Greenwich Mean Time to avoid issues of media being shipped across time zones.

The policy for data storage management may include a time period for how long data may be stored. It may also include encryption key generation and encryption instructions. The policy for the lifespan and/or expiration date of data may be common across all removable storage media, it may be maintained either directly by the device that reads and writes the removable storage media, or by a library device or changer which encloses the read/write device. Typically library devices and changers already have a management interface which may be extended to manage temporary and or confidentiality encryption keys. In the case where expiration dates are implemented, a library device represents a single point where multiple read/write devices may obtain time/date information, eliminating the need for each read/write device to maintain time/date information. If the read/write device or the library device sets policy and encryption keys there is no need for application software to be modified in any way to implement this embodiment.

According to another embodiment of the method for maintaining policy and/or confidentiality keys, a simple API may be defined to allow application software control over the policy. This API need only affect the read/write device firmware. Note that most application software takes a “lowest common feature set” approach to device management, so an ISV software may or may not support such an API. The benefit of this approach is that it allows for differing policies to be applied to different pieces of removable storage media.

Moving to decision state 108, a time signal is monitored to determine if the expiration condition has been satisfied. In one embodiment a real time device may be embedded within each piece of removable media to determine when the expiration condition has been satisfied. Alternately a broadcast time source (such as, but not limited to, the radio frequency atomic clock service) may be monitored instead of maintaining an internal real time clock.

One embodiment employs the use of a lifespan timer that specifies the useful life of the data in terms of relative hours, days, weeks, and/or years. This implementation has no reliance on accurate time and date information, and uses, for example a real time clock or simple counter/timer embedded within each piece of removable media to track relative time. It is irrelevant to the mechanism whether the timer/counter is an up counter or down counter, tracking either the age of the data or the time to expiration of the data. Other timing devices may also be used, such as other electronic, mechanical, or chemical timing devices.

The same basic mechanism can be implemented without the use of a real time device or time broadcast receiver and the associated power source, thereby reducing implementation costs significantly for the removable storage media. To implement this alternative embodiment the removable storage media may be assigned an expiration date instead of a lifespan, and the device that reads the removable storage media may either have a real time clock or access to an external real time clock or broadcast time service. The device reading the data may then compare the current real time information to the expiration condition of the removable media prior to reading any data. If the removable storage media data has expired, the device may then delete the temporary encryption key for the data. The encryption keys in this embodiment do not have to be on separate storage from the removable storage media itself; in fact the keys may be stored in a dedicated area on the removable storage media. Removable storage media typically have reserved areas for internal use by the device that is used to read and write the media. This is a practical place to store the encryption keys. This embodiment relies upon the firmware or the device reading the data to destroy expired data.

While at state 108, if the monitoring mechanism determines that the expiration condition is not satisfied, the process remains at state 108, and the monitoring mechanism continues to monitor. Once the expiration condition is met, the process 100 advances to state 110 where the temporary encryption key is deleted, rendering the data effectively destroyed. This may occur in any manner, such as a read/write device deleting the key, or circuitry configured for this purpose deleting the key.

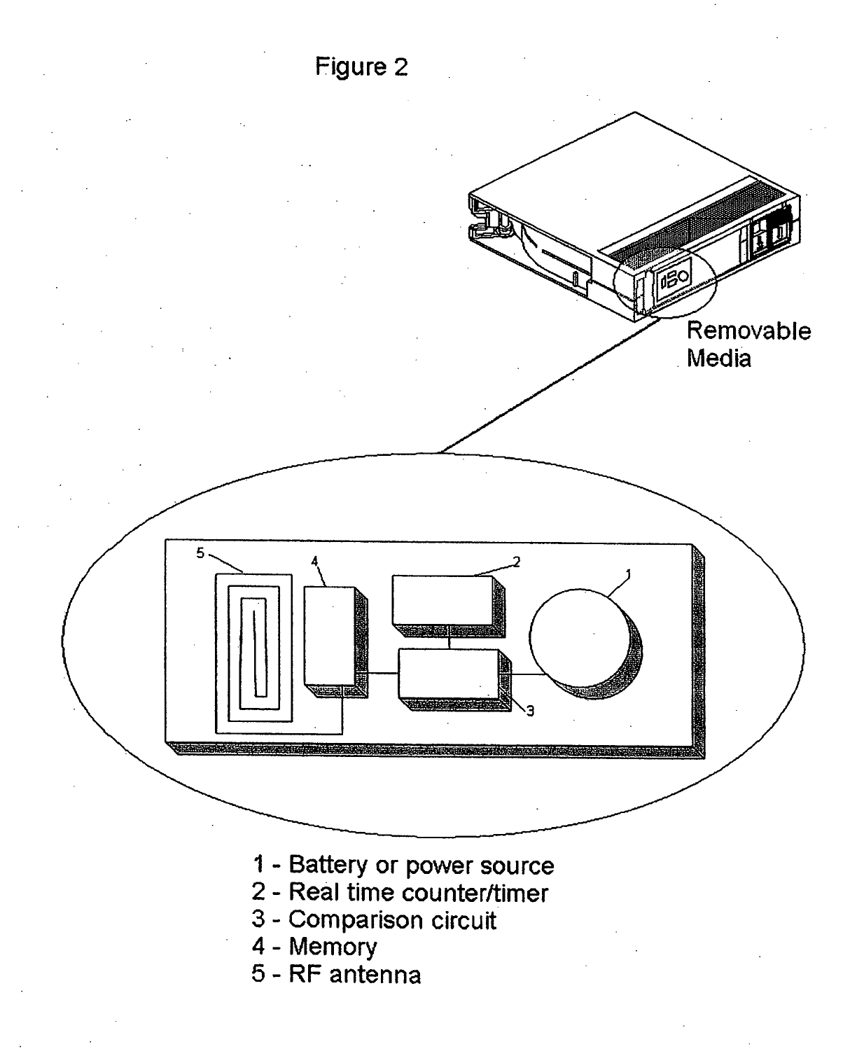

FIG. 2 illustrates an example of removable media configured to implement the process 100 of FIG. 1. The power source 1 supplies power for the other elements of the removable media. The power source 1 may be any type of power source, such as, but not limited to a battery, power cell, capacitive storage, or standard grid power. The type of power source used is largely inconsequential. Desirable qualities in the power source are low cost, small size, low weight, and low environmental impact.

Also shown in FIG. 2 is a real time counter/timer 2, which is used to determine whether or not the expiration condition has been met, such as in state 108 of process 100 of FIG. 1. The real time counter/timer 2 may comprise a real time device, or a counter, or a receiver for a broadcast time source, or it may comprise circuitry or firmware or software configured to receive time information from a source external to the removable media and output the time information to a comparison circuit 3. The comparison circuit 3 may comprise circuitry or firmware or software configured to receive the time information and store or receive the expiration condition, and based on comparison of the time information to the expiration condition determine whether or not the expiration condition has been met, such as in state 108 of process 100 of FIG. 1. Other types of timing devices may also be used. Upon the expiration condition being satisfied, the comparison circuit 3 produces a signal indicating that the expiration condition has been satisfied.

Memory 4 of FIG. 2 illustrates a memory for storing the temporary encryption key, and/or the expiration condition. In one embodiment memory 4 may be a non-volatile device such as, but not limited to flash memory or EEPROM. This non-volatile memory comprises an external interface such as, but not limited to, an RF read/write interface and/or an internal circuit responsible for deleting the temporary encryption key upon expiration. In another embodiment the memory 4 may be a volatile memory device such as, but not limited to SDRAM. This volatile storage may comprise both a small internal circuit configured to delete the temporary encryption key, and an external interface such as, but not limited to an RF read/write interface. Also shown in FIG. 2 is an RF antenna 5, coupled to the memory 4.

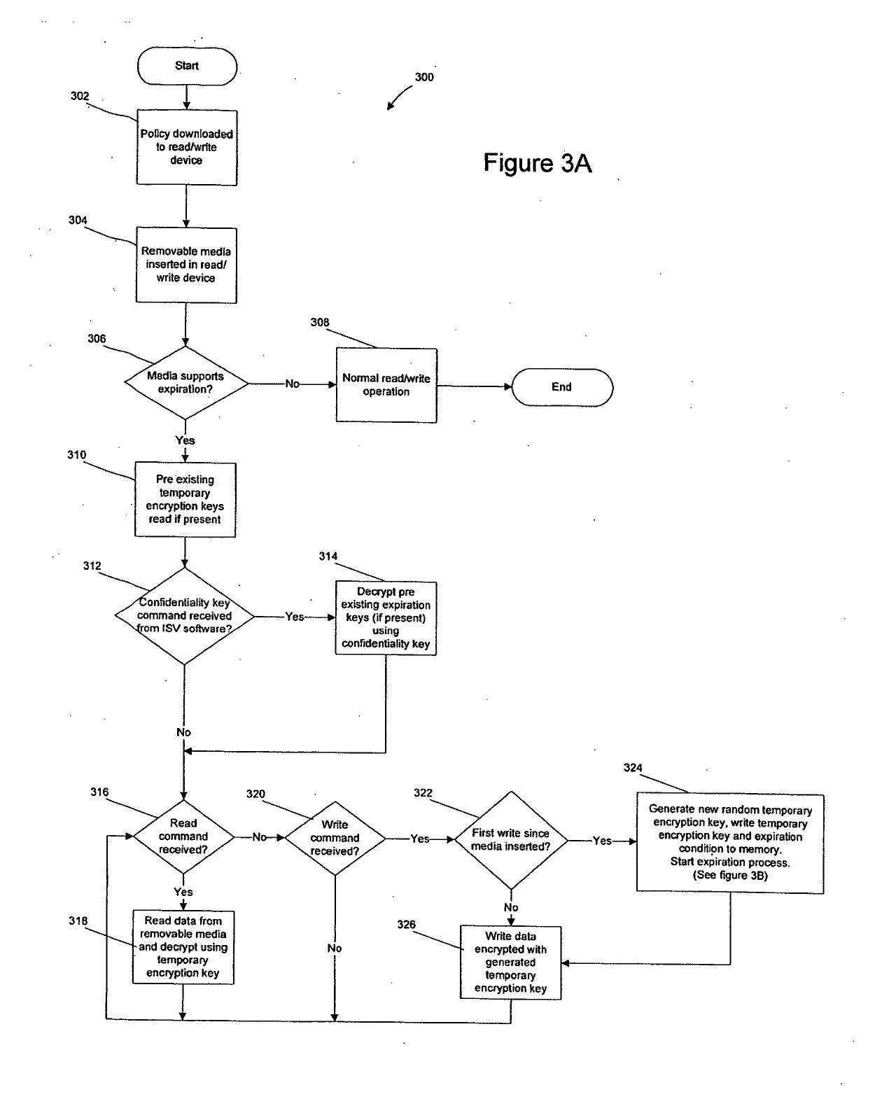

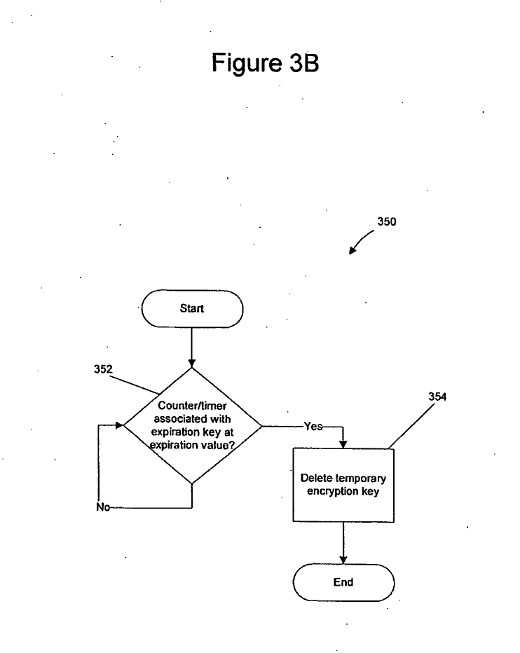

FIGS. 3A and 3B show an exemplary embodiment of the process 100 of FIG. 1 using the removable media of FIG. 2. Depending on the embodiment, states of process 300 can be removed, added, or rearranged. Starting at state 302 of FIG. 3A, the policy is downloaded to the read/write device. The read/write device will enforce the policy on all data storage media which it services. Proceeding to state 304, removable media is inserted into the read/write device. Insertion may be a manual human performed operation, or may be machine implemented. Once the removable media is in the read/write device, at state 306 the read/write device determines whether or not the media supports temporary encryption key management. If it does not conventional read/write operations occur in state 308, and the process 300 ends. If while at state 306 it is determined that the media does support temporary encryption key management, the read/write device then reads any existing temporary encryption keys at state 310. Advancing to state 312, if a confidentiality command has not been received from the software the read/write device proceeds to state 316. Otherwise the read/write device proceeds to state 314, where the read/write device decrypts the temporary encryption keys found in state 310, and then proceeds to state 316, where a determination is made as to whether or not a read command has been received. If a read command has been received, the read/write device performs the read in state 318 and then returns to state 316. If a read command has not been received, the read/write device proceeds to state 320 where it determines if a write command has been received. If no write command has been received the read/write device returns to state 316. If a write command has been received, the read/write device, in state 322, determines whether or not this is the first write command since the removable media has been inserted. If it is the first write command since insertion, at state 324 the read/write device generates a new temporary encryption key, and writes it and an expiration condition to memory 4 of FIG. 2. In one embodiment this encryption key will be used to encrypt all data written during this insertion session, however in other embodiments new encryption keys may be generated more or less frequently. A new expiration process is spawned, an embodiment of which is shown in FIG. 3B. After the new encryption key and expiration condition are stored in memory 4, or if at state 322, it is not the first write command since insertion, at state 326, the read/write device writes the data encrypted with the temporary encryption key associated with data written during this insertion session, and then returns to state 316. At this point the removable storage media may be removed from the read/write device.

FIG. 3B shows an embodiment of the expiration process 350 spawned at state 324 of process 300 described in FIG. 3A. Depending on the embodiment, states of process 350 can be removed, added, or rearranged. Starting at state 352, a comparison circuit 3 of FIG. 2 monitors a real time counter/timer 2 to determine whether or not the expiration condition has been satisfied. If it has not, the comparison circuit 3 continues to monitor. If the expiration condition has been satisfied, an indication signal is generated and an internal circuit responsible for deleting the temporary encryption key deletes the key at state 354. In some embodiments the process 350 may occur after the removable storage media has been removed from the read/write device.

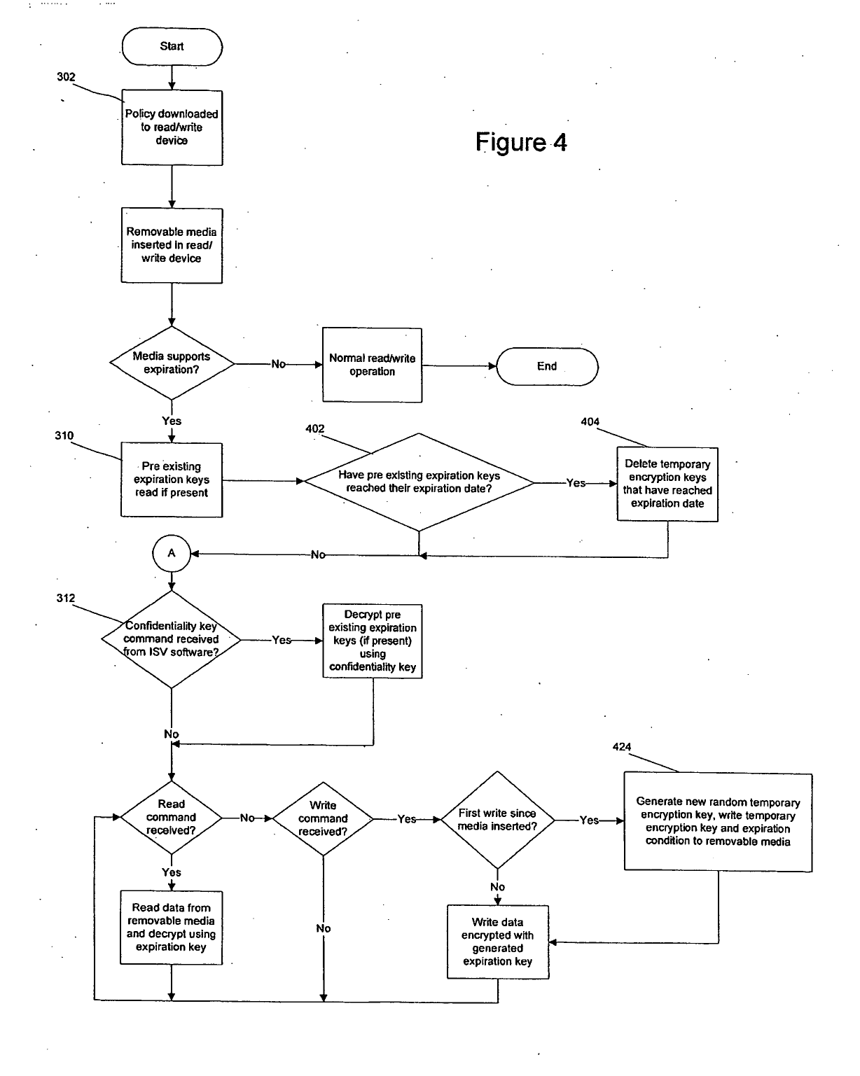

FIG. 4 illustrates process 400, which is an embodiment of the process 100 of FIG. 1, wherein determining whether or not the expiration condition has been satisfied (state 108 of process 100) is performed in the read/write device rather than on the removable media as in the processes 300 and 350 of FIGS. 3A and 3B. Depending on the embodiment, states of process 400 can be removed, added, or rearranged. Process 400 starts at state 302 and proceeds to state 310 via other states in a manner analogous to that described in process 300. Proceeding from state 310, the read/write device, at state 402, determines whether or not the expiration conditions for any pre-existing temporary encryption keys have been satisfied. If any expiration conditions have been satisfied, the read/write device deletes the temporary encryption keys associated with the satisfied expiration conditions. Once the appropriate keys have been deleted or if no expiration conditions have been met, the read/write device continues to state 312, which is analogous to state 312 described in process 300. Thereafter process 400 is analogous to process 300, excepting state 424 where the read/write device generates a new temporary encryption key, and writes it and an expiration condition to the removable media.

Another embodiment may be implemented without the requirement for support from applications used to write the data to the removable storage media. A simple API may be defined to allow application software to control the policy and process.

In some embodiments no hardware modifications are necessary for many drives. Several commercially shipping read/write devices for removable media already support encryption in hardware and the ability to read/write auxiliary non-volatile storage devices present in the case or carrier for removable storage media. Minimal firmware modifications may be necessary to the read/write devices for removable storage media.

Some embodiments require a unique type of removable storage media. For those embodiments requiring the timely destruction of expired data, this mechanism represents an added value which may be associated with each piece of removable storage media. Other embodiments may use standard media; however it may still be advantageous to create a new media identifier to associate value with removable storage media.

One embodiment is self contained on the removable storage media, such that the temporary encryption key is deleted upon satisfaction of the expiration condition even if the piece of removable storage media containing the time sensitive data is lost, stolen, or stored at an off-site location with high access latency.

In some embodiments, in addition to the use of encryption for data expiration, temporary encryption keys may also be used to guard the confidentiality of data that has not yet expired.

One embodiment can guarantee that data is rendered incomprehensible, or effectively destroyed as soon as the data has out lived its useful business, regulatory, or legal life.

Some embodiments may make use of a metadata area which exists in most removable media reserved for use by the media read/write device. The metadata area often contains information such as the media type, a media identifier (similar to a serial number, but not guaranteed unique), and in the case of tape media, a directory containing offsets (typically tachometer counts) to records written to the tape. These different types of data are often referred to as metadata, and generally do not contain any information written by a user of the media, but are substantially necessary for the user data to be read. The metadata is generally used only by the removable media read/write device itself. This metadata is not limited to the types described above.

Some embodiments use the data expiration logic to destroy the metadata or set a metadata flag (do not read, for example) on the removable media. Destroying the metadata or setting a metadata flag is advantageous compared to destroying all the unencrypted data since there is much less metadata than user data, so the process can be accomplished quickly. In some embodiments this avoids the need for encryption hardware. Destroying the metadata or setting a metadata flag will make the removable media appear to the read/write device as either invalid media, blank media, or damaged media. Consequently, reading the data, though not impossible, would require significant time and expense.

While the above detailed description has shown, described, and pointed out novel features as applied to various embodiments, it will be understood that various omissions, substitutions, and changes in the form and details of the device or processes illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A method of data storage management, the method comprising:
storing data encrypted with a temporary encryption key;
storing the temporary encryption key;
storing an expiration condition for the temporary encryption key;
determining whether the expiration condition has been satisfied; and
deleting the temporary encryption key after the expiration condition has been satisfied.

2. The method of claim 1, further comprising encrypting the temporary encryption key with a confidentiality encryption key.

3. The method of claim 1, wherein the data and the temporary encryption key are stored in different storage devices.

4. The method of claim 1, wherein the data and the expiration condition are stored in different storage devices.

5. The method of claim 1, wherein the data, the temporary encryption key and the expiration condition are stored on a single removable data storage medium.

6. The method of claim 1, further comprising removing the removable data storage media from a read/write device after storing the expiration condition and prior to determining whether the expiration condition has been satisfied.

7. The method of claim 1, wherein determining whether the expiration condition has been satisfied comprises receiving a time indication from an external source and comparing the time indication with the expiration condition.

8. The method of claim 1, wherein determining whether the expiration condition has been satisfied comprises generating a time indication and comparing the time indication with the expiration condition.

9. A removable data storage medium device comprising:
means for storing a temporary encryption key, data encrypted with the temporary encryption key, and an expiration condition; and
means for deleting the temporary encryption key after receiving an indication signal that the expiration condition has been satisfied.

10. The device of claim 9, further comprising:
means for receiving a time-varying signal from an external source; and
means for determining whether the expiration condition has been satisfied, the means for determining being configured to selectively generate the indication signal based at least in part on a comparison of the time-varying signal to the expiration condition.

11. The device of claim 9, further comprising:
means for generating a time-varying signal; and
means for determining whether the expiration condition has been satisfied, the means for determining being configured to selectively generate the indication signal based at least in part on a comparison of the time-varying signal to the expiration condition.

12. A removable data storage medium device, comprising:
a persistent data storage, configured to store data encrypted with a temporary encryption key, the temporary encryption key, and an expiration condition for the temporary encryption key; and
a control circuit configured to delete the temporary encryption key from the persistent data storage after receiving an indication signal that the expiration condition has been satisfied.

13. The device of claim 11, further comprising:
a first circuit configured to receive a time-varying signal from an external source; and
a second circuit configured to generate an indication signal based on a comparison of the time-varying signal to the expiration condition.

14. The device of claim 11, further comprising:
a first circuit configured to provide a time-varying signal; and
a second circuit configured to generate an indication signal based on a comparison of the time-varying signal to the expiration condition.

15. A computer readable medium comprising instructions which when executed perform a method of data storage management, the method comprising:
storing data encrypted with a temporary encryption key;
storing the temporary encryption key;
storing an expiration condition for the temporary encryption key;
determining whether the expiration condition has been satisfied; and
deleting the temporary encryption key after the expiration condition has been satisfied.

16. The computer readable medium of claim 15, wherein the method further comprises encrypting the temporary encryption key with a confidentiality encryption key.

17. The computer readable medium of claim 15, wherein the method further comprises determining the expiration condition.

18. The computer readable medium of claim 15, wherein the method further comprises determining the temporary encryption key.

19. The computer readable medium of claim 15, wherein the method further comprises encrypting the data with the temporary encryption key.

20. The computer readable medium of claim 15, wherein the method further comprises comparing a time indication with the expiration condition.

21. A method of data storage management, the method comprising:
storing user data on a removable data storage medium comprising access data, the access data being substantially necessary for the user data to be read;
storing an expiration condition for the user data;
determining whether the expiration condition has been satisfied; and
deleting the access data after the expiration condition has been satisfied.

22. The method of claim 21, wherein the access data comprises metadata or an encryption key.

23. The method of claim 21, wherein deleting the access data comprises setting a flag on the removable data storage medium.
